(19) United States
(12) Patent Application Publication
(10) Pub. No.: US 2024/0274148 A1
(43) Pub. Date: Aug. 15, 2024

(54) SOUND SOURCE SEPARATION USING ANGULAR LOCATION

(71) Applicant: Intel Corporation, Santa Clara, CA (US)

(72) Inventors: Jesus Ferrer Romero, Guadalajara (MX); Hector Cordourier Maruri, Guadalajara (MX); Georg Stemmer, Munich (DE); Willem Beltman, West Linn, OR (US)

(73) Assignee: Intel Corporation, Santa Clara, CA (US)

(21) Appl. No.: 18/645,793

(22) Filed: Apr. 25, 2024

(51) Int. Cl. G10L 21/0272; G10L 25/30

(52) U.S. Cl. CPC G10L 21/0272; G10L 25/30

(57) ABSTRACT

Systems and methods for audio source separation. A deep learning-based system uses an azimuth angle location to separate an audio signal originating from a selected location from other sound. Techniques are disclosed for steering a virtual direction of a microphone towards a selected speaker. A deep-learning based audio regression method, which can be implemented as a neural network, learns to separate out various speakers by leveraging spectral and spatial characteristics of all sources. The neural network can focus on multiple sources in multiple respective target directions, and cancel out other sounds. A user can choose which source to listen to. The network can use the time-domain signal and a frequency-domain signal to separate out the target signal and generate a separated audio output. The direction of the selected speaker relative to the microphone array can be input to the system as a vector.

### TECHNICAL FIELD

This disclosure relates generally to sound source separation, and in particular to separating out audio originating from a desired location.

### BACKGROUND

Audio source separation includes separating a mixture of sounds into individual sources. When a number of people are talking simultaneously, audio source separation can allow a listening device to enhance a selected user's voice above the competing voices of other speakers. Thus, audio source separation can have positive effects on verbal communication and speech recognition in various environments. However, it is difficult for devices to identify a target signal among a mixture of voices in real world scenarios.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an example of a virtual directional microphone device having a microphone array and performing audio source separation, in accordance with various embodiments.

FIG. 2 is a diagram of an example sound source separation system, in accordance with various embodiments.

FIG. 3 is a block diagram of a deep neural network (DNN) module that can be used for a sound source separation system, in accordance with various embodiments.

FIG. 4 is a block diagram illustrating an example of a neural network architecture that can perform audio source separation, in accordance with various embodiments.

FIG. 5 is a flow chart of an example method for sound source separation, in accordance with various embodiments.

FIG. 6A is a diagram illustrating a simulated room having a microphone array, in accordance with various examples.

FIG. 6B illustrates examples of RIRs obtained for a simulated room, in accordance with various embodiments.

FIG. 7 is a block diagram of an example computing device, in accordance with various embodiments.

### DETAILED DESCRIPTION

### Overview

Systems and methods are presented herein to provide a source location to a source separation network, allowing the audio signal from the source location to be separated out and enhanced. In particular, rather than separate out each individual source, techniques are presented for separating out one audio signal from other audio signals. The systems and methods utilize input signals from a two-microphone array and determine a specific angle of arrival. The angle of arrival is used to determine a direction from which the target signal is emitted. When the location of the selected signal (e.g., the desired speaker) is known, the system can steer its virtual microphone direction towards the selected signal and filter out other sounds.

Audio source separation technology can be included in computing devices having a microphone that can be used for calls, teleconferencing, and other audio exchanges. In particular, audio source separation can be used to enhance a user's voice above other environmental noise and competing speech from other people in the environment. However, it can be challenging to identify the correct signal to enhance (i.e., identifying the selected speaker's voice) among a mixture of concurrent speech and voice sounds. In some examples, the selected speaker's voice may not be the loudest or predominant signal. In one example, the multiple people can simultaneously attend a videoconference on a single device, and prefer to have only one person's voice enhanced and transmitted.

One method for audio source separation includes using microphone arrays and beamforming techniques such as delay-and-sum, MVDR, Frost, etc. The beamforming techniques can enhance the audio coming from a certain direction. Another method for audio source separation is a Generalized Sidelobe Canceller (GSC). GSC is generally based in adaptive filtering theory, and as such the result of GSC is a linear filter that approximates the optimal solution (e.g., a selected direction for audio signal enhancement vs. other directions which can be filtered). Blind Source Separation (BSS) can improve a source signal given a limited and pre-determined (known) number of sources, limiting its practical applicability for a meeting room with many people.

Systems and methods are presented herein for a deep learning-based system that uses an azimuth angle location to separate an audio signal originating from a selected location from other sound. Techniques are disclosed for steering a virtual direction of a microphone towards a selected speaker. When the techniques are used, for example, during a teleconference, remote participants will hear the selected speaker without interference. In various examples, the audio source separation systems and methods include a neural network that learns to separate out various speakers by leveraging spectral and spatial characteristics of all sources. Thus, in some examples, the neural network can focus on multiple sources in multiple respective target directions, and cancel out other sounds. In some examples, a listener can choose which source to listen to. The systems and methods described herein can directly generate the time-domain signal and are not limited to linear modeling of audio source separation.

According to various implementations, an audio source separation module can include a deep-learning based audio regression method, which can be implemented as a neural network, such as a deep neural network (DNN). As described herein, a DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (generated during feature extraction) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor that includes one or more output activations (also referred to as “output elements”).

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Sound Source Location Identification

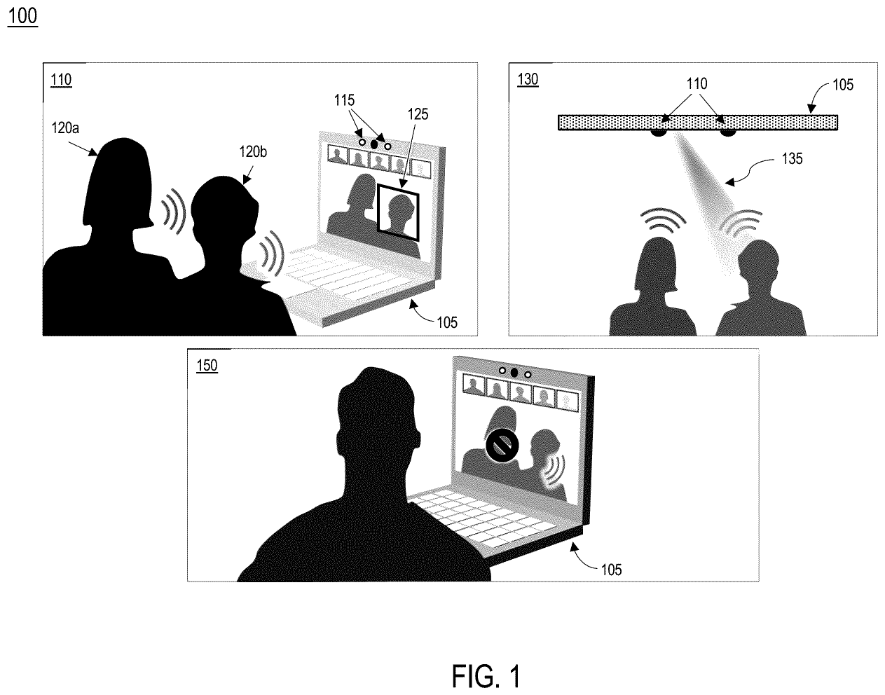

FIG. 1 is a block diagram of an example 100 of a virtual directional microphone device having a microphone array and performing audio source separation, in accordance with various embodiments. In particular, a first diagram 110 shows a computing device 105 having a microphone array 115 and two talkers 120a, 120b. As shown in the example 100, the locations of the talkers 120a, 120b relative to the computing device 105 can be determined using a camera and imaging technology. The camera may already be in use as part of a video conference, as depicted on the screen of the computing device 105. In the example of FIG. 1, the desired talker is the second talker 120b, and using the location of the second talker 120b relative to the computing device 105, the virtual directional microphone can be directed towards the second talker 120b. The second diagram 130 shows a top view of the talkers 120a, 120b relative to the computing device 105. The second diagram 130 illustrates the virtual direction 135 of the microphone array 115 when the microphone array is steered towards the second talker 120b. The third diagram 150 illustrates the video conference with the second talker 120b audible and the first talker 120a muted.

In some examples, the virtual directional microphone can be used to separate the first 120a talker and the second 120b talker in parallel. Once the signals from each talker 120a, 120b are separated, in some examples, other participants in the video conference can select which speaker to listen to (and/or which speaker to silence) in real time. Thus, the microphone array can record both talkers, and the virtual directional microphone performs audio source separation to separate out each talker voice from the other voice (or voices).

### Example Sound Source Separation System Overview

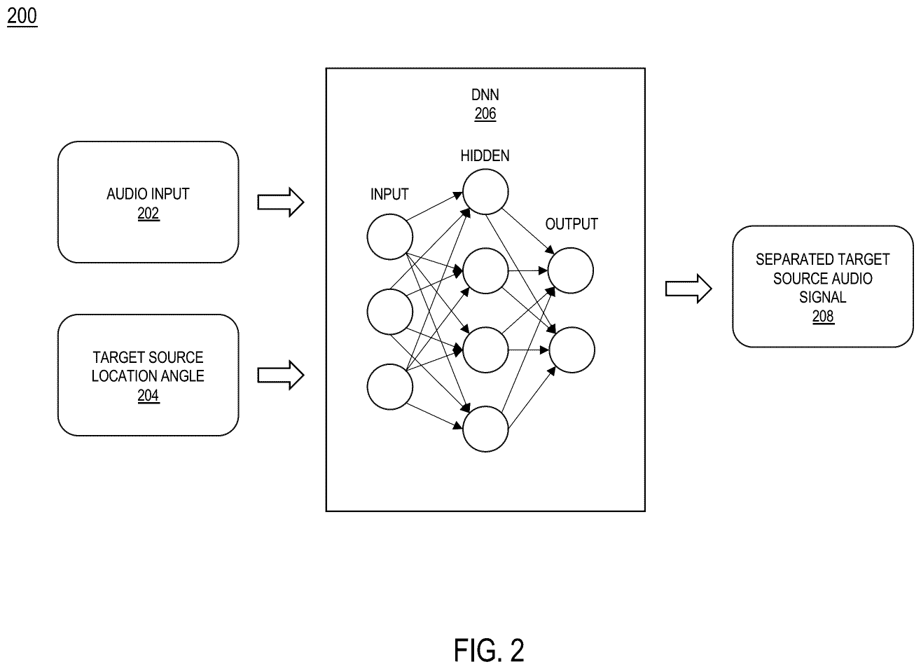

FIG. 2 is a diagram of an example sound source separation system 200, in accordance with various embodiments. In particular, as shown in FIG. 2, the system 200 includes a neural network 206, which receives an audio input 202 and a target source location angle 204. The neural network 206 can be a regression neural network that uses the audio input 202 and the target source location angle 204 as input and generates a separated target source audio output signal 208 including the signal emanating from the target source located at the target source location angle 204. According to various implementations, the neural network 206 can be a deep neural network, as described in greater detail below.

### Example DNN System

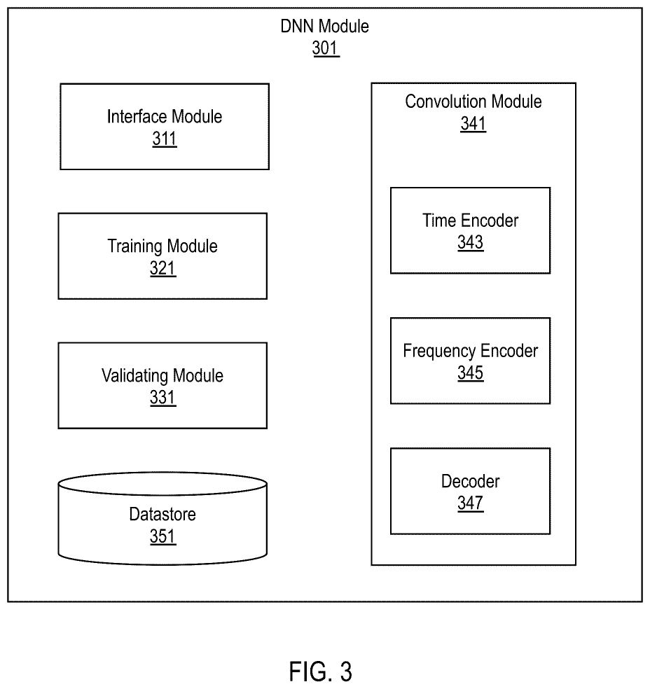

FIG. 3 is a block diagram of a deep neural network (DNN) module 301 that can be used for a sound source separation system, in accordance with various embodiments. In the embodiments of FIG. 3, the DNN module 301 includes an interface module 311, a training module 321, a validating module 331, a convolution module 341, and a datastore 351. In other embodiments, alternative configurations, different or additional components may be included in the DNN module 301. Further, functionality attributed to a component of the DNN module 301 may be accomplished by a different component included in the DNN module 301 or a different module or system, such as any of the neural networks and/or deep learning systems described herein.

The interface module 311 facilitates communications of the DNN module 301 with other modules or systems. For example, the interface module 311 establishes communications between the DNN module 301 with an external database to receive data that can be used to train DNNs or input into DNNs to perform tasks. As another example, the interface module 311 supports the DNN module 301 to distribute DNNs to other systems, e.g., computing devices configured to apply DNNs to perform tasks.

The training module 321 trains DNNs by using a training dataset. In some examples, the training dataset can be generated using synthetic audio samples. In some examples, the training dataset includes two or more speakers, with each speaker being an audio source. In some examples, multiple datasets can be used to provide a variety of audio source types (e.g., human speech, instruments, animals, environmental sounds, etc.). For each sample in a dataset, a number of random audio sources can be selected and a source angle can be assigned to each selected audio source. Each of the selected audio sources can be rendered from a respective direction based on the assigned source angle, wherein rendering a selected audio source from a respective direction includes adjusting the audio source recording as received at each microphone of the microphone array. Audio sources can be mixed to produce a mixed signal training input data. The training input data includes the assigned source angle for each source. To generate the training output, the convolution module 341 performs audio source separation on the mixed signals based on the assigned source angle for each audio source and separates the signals to output the respective signals for each audio source.

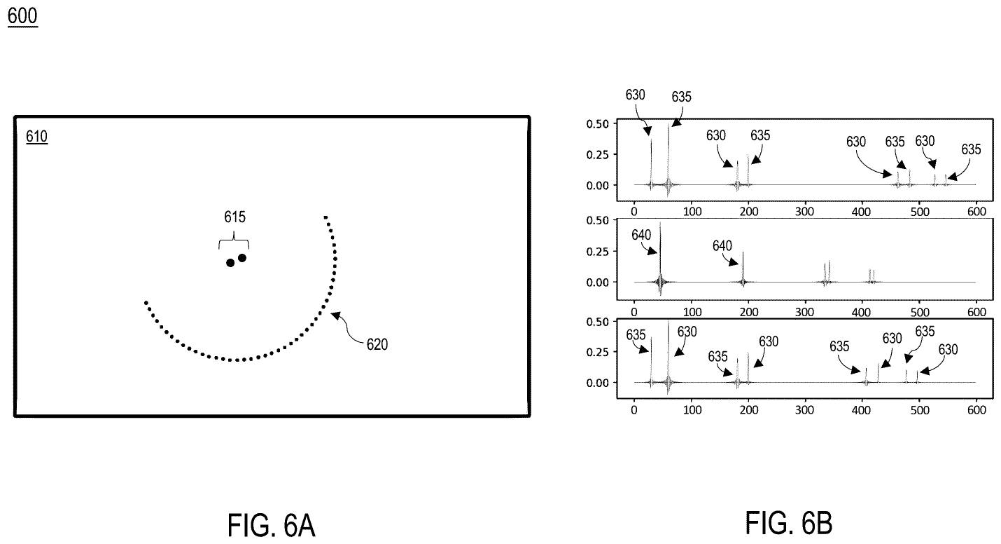

In some examples, the synthetic training data can be generated using impulse responses of multiple different rooms. The room impulse responses for many different rooms (e.g., hundreds of different rooms) can be used. A stereo mix can be randomly created with a scene where multiple audio sources are located at different positions. The different positions can each correspond to a selected angle along a semicircle relative to the microphone array, as explained in greater detail with respect to FIGS. 6A-6B.

In an embodiment where the training module 321 trains a DNN to separate out the target signal and generate an output separated target audio signal, the training dataset includes training signals including multiple sources (including the target audio signal), and training labels. The training labels describe ground-truth locations (e.g., angles) of each of the sound sources in the training signals relative to the microphone array. In some embodiments, each label in the training dataset corresponds to an angle (with respect to a center line and plane) in a training stereo sound space. In some embodiments, each label in the training dataset corresponds to a location in a training stereo sound space. The DNN receives operates on the combines signals to separate out respective signals corresponding to each source based on the ground-truth location of each source, and the training module 321 can compare the separated signals generated by the DNN to the original signals. In some embodiments, a part of the training dataset may be used to initially train the DNN, and the rest of the training dataset may be held back as a validation subset used by the validating module 331 to validate performance of a trained DNN. The portion of the training dataset not including the tuning subset and the validation subset may be used to train the DNN.

The training module 321 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 500, or even larger.

The training module 321 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input signal, such as frequency, volume, and other spectral characteristics. The output layer includes labels of angles and/or locations of sound sources in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input signals to perform feature extraction. In some examples, the feature extraction is based on a spectrogram of an input sound signal. A pooling layer is used to reduce the volume of input signal after convolution. It is used between two convolution layers. A fully connected layer involves weights, biases, and neurons. It connects neurons in one layer to neurons in another layer. It is used to classify signals between different categories by training. Note that training a DNN is different from using the DNN in real-time and when using a DNN to process data that is received in real-time, latency can become an issue that is not present during training, when the data set can be pre-loaded.

In the process of defining the architecture of the DNN, the training module 321 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 321 defines the architecture of the DNN, the training module 321 inputs a training dataset into the DNN. The training dataset includes a plurality of training samples. An example of a training sample includes source location of a feature in an audio sample and a ground-truth location of the feature. The training module 321 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 321 uses a cost function to minimize the error.

The training module 321 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 321 finishes the predetermined number of epochs, the training module 321 may stop updating the parameters in the DNN. The DNN having the updated parameters is referred to as a trained DNN.

The validating module 331 verifies accuracy of trained or compressed DNNs. In some embodiments, the validating module 331 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 331 may determine an accuracy score measuring the precision, recall, or a combination of precision and recall of the DNN. The validating module 331 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 331 may compare the accuracy score with a threshold score. In an example where the validating module 331 determines that the accuracy score of the augmented model is less than the threshold score, the validating module 331 instructs the training module 321 to re-train the DNN. In one embodiment, the training module 321 may iteratively re-train the DNN until the occurrence of a stopping condition, such as the accuracy measurement indication that the DNN may be sufficiently accurate, or a number of training rounds having taken place.

The convolution module 341 performs real-time data processing for audio source separation. In some examples, the convolution module 341 can also perform additional real-time data processing, such as for speech enhancement, dynamic noise suppression, and/or self-noise silencing. In the embodiments of FIG. 3, the convolution module 341 includes time domain encoder 343, a frequency domain encoder 345, and a time domain decoder 347. In some examples, the time domain encoder 343 is a convolutional time domain encoder, the frequency domain encoder 345 is a convolutional frequency domain spectrum encoder, and the time domain decoder 347 is a convolutional time domain decoder. In other embodiments, alternative configurations, different or additional components may be included in the convolution module 341. Further, functionality attributed to a component of the convolution module 341 may be accomplished by a different component included in the convolution module 341, the DNN module 301, or a different module or system.

The frequency encoder 345 receives short time Fourier transform (STFT) spectra. In various examples, the input data to the frequency encoder 345 is frequency domain STFT spectra derived from input audio data. The input data includes input tensors which can each include multiple frames of data.

In various examples, a STFT is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance as a spectrogram. In some examples, the STFT is a discrete time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder 347, or before being input to the decoder 347. By inverting the STFT, the encoded frequency domain signal from the frequency encoder 345 can be recombined with the encoded time domain signal from the time encoder 343. One way of inverting the STFT is by using the overlap-add method, which also allows for modifications to the STFT complex spectrum. This makes for a versatile signal processing method, referred to as the overlap and add with modifications method. In various examples, the output from the decoder 347 is an audio output signal representing the input signal for a selected audio source. In some examples, the output from the decoder 347 includes multiple separated audio output signals, each representing the input signal for a respective input audio source.

The datastore 351 stores data received, generated, used, or otherwise associated with the DNN module 301. For example, the datastore 351 stores the datasets used by the training module 321 and validating module 331. The datastore 351 may also store data generated by the training module 251 and validating module 331, such as the hyperparameters for training DNNs, internal parameters of trained DNNs (e.g., weights, etc.), data for sparsity acceleration (e.g., sparsity bitmap, etc.), and so on. In some embodiments the datastore 351 is a component of the DNN module 301. In other embodiments, the datastore 351 may be external to the DNN module 301 and communicate with the DNN module 301 through a network.

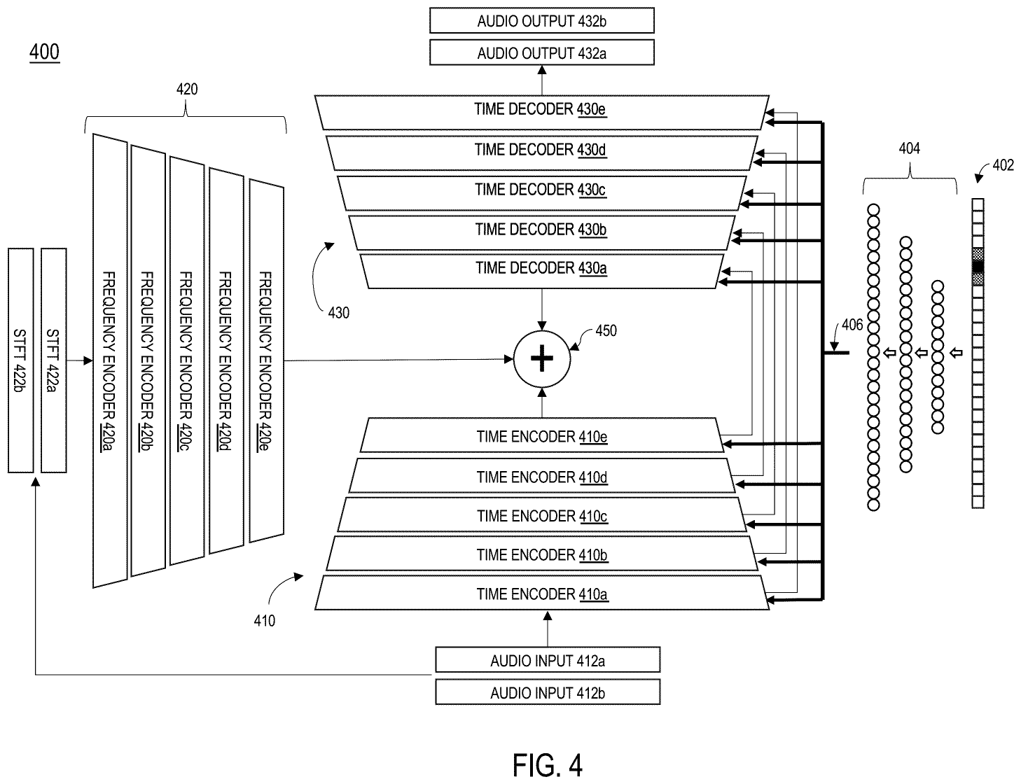

FIG. 4 is a block diagram illustrating an example of a neural network architecture 400 that can perform audio source separation, in accordance with various embodiments. The neural network architecture includes time domain input signals 412a, 412b, each from a respective microphone of a microphone array, and corresponding frequency domain input signals 422a, 422b, each from a respective microphone of the microphone array. In some examples, the frequency domain input signals 422a, 422b are spectra transformed from the time domain input signals 412a, 412b. In some examples, a short-time Fourier transform is used to transform the time domain input signals 412a, 412b to frequency domain STFT spectra.

The time domain input signals 412a, 412b are input to a time domain encoder 410, which includes multiple time domain encoder layers 410a, 410b, 410c, 410d, 410e. In some examples, the time domain encoder 410 is a convolutional encoder and includes convolutional U-Nets for time domain signals. The time domain encoder 410 receives the two channels of time domain input signals 412a, 412b at a first time domain encoder convolutional layer 410a. The time domain encoder 410 also receives a one-dimensional vector 402 input representing the angle (and/or direction) of a target source relative to the microphone array.

The one-dimensional vector 402 includes a plurality of elements, each element representing the angle of a target source relative to the microphone array. In particular, the angle of the target source can be input to the neural network architecture 400 as a vector 402, where the vector includes a value for each of multiple potential angles of the target source relative to the microphone array. In one example, the target source can be anywhere in front of a laptop microphone (and thus the target source can be anywhere on a 180 degree semicircle in front of the laptop microphone), the vector may be a 180 element vector with each element of the vector representing one degree of the semi-circle (and thus representing 180 different directions in front of the laptop). In some examples, the vector may also include an element representing a zero degree angle, and thus the vector with each element representing one degree of the semi-circle can be a 181 element vector. If the target source (selected talker) is at 60 degrees relative to the microphone array, the 180 element vector will have zero values in all elements except around element 60. At element 60, the 180 element vector will have a value of 1, and at elements 59 and 61, the 180 element vector can also have non-zero values. For instance, elements 59 and 61 can have values of 0.5. In some examples, the values of elements 59, 60, and 61 are based on a Gaussian bell curve. In various examples, the values of the elements on either side of the element representing the target source can have different non-zero values. In some examples, elements 58 and 62 may also have non-zero values, but the values of elements 58 and 62 are smaller non-zero values than the values of elements 59 and 61. In some examples, when the vector includes a greater number of elements representing smaller angle differentials between each element, it is more likely that elements next to the neighboring elements (e.g., elements 58 and 62 of the example above) may have non-zero values.

In some examples, the vector 402 input includes more or fewer elements to represent the angle that is one of a selected number of angles between zero degrees and 180 degrees. For instance, the angles can be 0°, 2°, 4°, 8°, 10°, . . . , 180°, and the vector can have 91 elements. In another example, the represented angles can be closer together (e.g., 0°, 0.5°, 1°, 1.5°, 2°, . . . , 180°), and the vector can have more elements. In other examples, the angles can be further apart (e.g., 0°, 5°, 10°, 15°, 20°, . . . , 180°) and the vector can have fewer elements. In some examples, the input vector 402 includes identification of multiple target audio signals from multiple respective directions, and two or more elements of the vector can have the value of 1 (with neighboring elements having smaller non-zero values). The multiple target audio signals can be separated from the input signal simultaneously. Note that the input vector 402 is a real-time parameter, which can change over time if, for example, the talker is moving. In some examples, the closest angle to the target source location can be identified by any means for generation of the vector input 402. In some examples, image data is used to identify the target source location. In some examples, audio data is used to identify the target source location.

In some examples, in the vector 402 shown in FIG. 4, each element represents an angle with respect to the microphone array, and the element that is colored black is the element representing the angle of the target source with respect to the microphone array. In some examples, the elements that are colored white have a value of zero and the element that is colored black has a value of one. The neighboring elements to the black-colored element each have a value between zero and one. In some examples, the neighboring elements to the black-colored element have different values from each other. For instance, if the target source angle is slightly different from the value of the black-colored element and closer to one neighboring element than the other, the neighboring element with that the target source angle is closer to may have a higher value than the other neighboring element on the other side of the black-colored element.

In various examples, the vector component input is processed by multiple fully connected neural network layers (vector component layers 404). In some examples, the vector component layers 404 expand the coordinates 402 into a vector and/or a tensor, using methods similar to the methods used by neural network encoders and/or neural network decoders. In some examples, expanding the input to the neural network can improve neural network training routines and/or training outcomes. The output 406 of the vector component layers 404 is input to each layer 410a, 410b, 410c, 410d, 410e of the time domain encoder 410. The neural network 400 uses the output 406 from the vector component layers 404 to transform the audio time domain input signals 412a, 412b to produce the audio output signals 432a, 432b for the target source signal. The output signals 432a, 432b include sound from the direction indicated in the input vector 402, and are clean of sound from any other direction.

The first time domain encoder convolutional layer 410a processes the two channels of time domain input signals 412a, 412b and the output of the vector component layers 404, and outputs 128 channels of time domain outputs to a second time domain encoder convolutional layer 410b. The second time domain encoder convolutional layer 410b receives the 128 channels of time domain signals and the output of the vector component layers 404, and outputs 256 channels of time domain outputs to a third time domain encoder convolutional layer 410c. The third time domain encoder convolutional layer 410c receives the 256 channels of time domain signals and the output of the vector component layers 404, and outputs 512 channels of time domain outputs to a fourth time domain encoder convolutional layer 410d. The fourth time domain encoder convolutional layer 410d receives the 512 channels of time domain signals and the output of the vector component layers 404, and outputs 1024 channels of time domain outputs to a fifth time domain encoder convolutional layer 410e. The fifth time domain encoder convolutional layer 410e receives the 1024 channels of time domain signals and the output of the vector component layers 404, and outputs 2048 channels of time domain outputs. In some examples, the output from fifth time domain encoder convolutional layer 410e is the output from the time domain encoder 410. The output from the time domain encoder 410 is input to an adder 450.

The frequency domain input signals 422a, 422b are input to a frequency domain encoder 420, which includes multiple frequency domain encoder layers 420a, 420b, 420c, 420d, 420e. In some examples, the frequency domain encoder 420 is a convolutional encoder for frequency domain STFT spectra. In some examples, the frequency encoder 420 allows the neural network 400 to focus on specific spectral differences for voice separation. The frequency domain encoder 420 receives the two channels of spectra (frequency domain input signals 422a, 422b) at a first frequency domain encoder convolutional layer 420a and outputs 128 channels of frequency domain outputs to a second frequency domain encoder convolutional layer 420b. The second frequency domain encoder convolutional layer 420b receives the 128 channels of time domain signals and outputs 256 channels of frequency domain outputs to a third frequency domain encoder convolutional layer 420c. The third frequency domain encoder convolutional layer 420c receives the 256 channels of frequency domain signals and outputs 512 channels of frequency domain outputs to a fourth frequency domain encoder convolutional layer 420d. The fourth frequency domain encoder convolutional layer 420d receives the 512 channels of frequency domain signals and outputs 1024 channels of frequency domain outputs to a fifth frequency domain encoder convolutional layer 420e. The fifth frequency domain encoder convolutional layer 420e receives the 1024 channels of frequency domain signals and outputs 2048 channels of frequency domain outputs. In some examples, the output from fifth frequency domain encoder convolutional layer 420e is the output from the frequency domain encoder 420. The output from the frequency domain encoder 420 is input to the adder 450, where it is combined with the output from the time domain encoder 410.

The output from the adder 450 is received by a time domain decoder 430. The time domain decoder 430 includes multiple time domain decoder layers 430a, 430b, 430c, 430d, 430e. In some examples, the time domain decoder 430 is a convolutional decoder and includes convolutional U-Nets for time domain signals. The time domain decoder 430 also receives an input representing the vector direction for the selected target source signal. In particular, the output 406 of the vector component layers 404 is input to each layer 430a, 430b, 430c, 430d, 430e of the time domain decoder 430. The neural network 400 uses the output 406 from the vector component layers 404 to produce the target source audio output 432a, 432b that for the vector 402 direction of the target source. The time domain decoder also receives output signals directly from corresponding layers of the time domain encoder. In particular, each layer 430a, 430b, 430c, 430d, 430e of the time domain decoder receives the output signal from the corresponding layer 410a, 410b, 410c, 410d, 410e that produced the same number of output channels and the decoder layer 430a, 430b, 430c, 430d, 430e receives as input.

The first time domain decoder convolutional layer 430a processes the 2048 channels of time domain input signals from the adder 450, 2048 channels of time encoder signals from the time encoder layer 410e, and the output 406 of the vector component layers 404, and outputs 1024 channels of time domain outputs to a second time domain decoder convolutional layer 430b. The second time domain decoder convolutional layer 430b receives the 1024 channels of time domain signals from the first time domain decoder convolutional layer 430a, 1024 channels of time encoder signals from the time encoder layer 410d, and the output 406 of the vector component layers 404, and outputs 512 channels of time domain outputs to a third time domain decoder convolutional layer 430c. The third time domain encoder convolutional layer 430c receives the 512 channels of time domain signals from the second time domain decoder convolutional layer 430b, 512 channels of time encoder signals from the time encoder layer 410c, and the output 406 of the vector component layers 404, and outputs 256 channels of time domain outputs to a fourth time domain decoder convolutional layer 430d. The fourth time domain decoder convolutional layer 430d receives the 256 channels of time domain signals from the third time domain decoder convolutional layer 430c, 256 channels of time encoder signals from the second time encoder layer 410b, and the output 406 of the vector component layers 404, and outputs 128 channels of time domain outputs to a fifth time domain decoder convolutional layer 430e. The fifth time domain decoder convolutional layer 430e receives the 128 channels of time domain signals from the fourth time domain decoder convolutional layer 430d, 128 channels of time domain signals from the first time domain encoder convolutional layer 410a, and the output 406 of the vector component layers 404, and outputs two channels of time domain outputs 632a, 632b. In some examples, the output from fifth time domain decoder convolutional layer 430e is the output from the time domain decoder 430, and the output from the decoder 430 is the output from the neural network architecture 400.

In some examples, the time domain encoder 410 and the frequency domain encoder 420 can have a shared cross-domain bottleneck, such that both the time domain encoder 410 output and the frequency domain encoder 420 output are added into additional encoder layers before reaching the decoder 430.

The neural network architecture 400 including the time domain encoder 410 and the time domain decoder 430, with multiple blocks and block-wise skip connections, can be a U-Net. The addition of the frequency domain encoder 420 results in the additional frequency domain encoder 420 output, which is combined with the time domain encoder 410 output on the U-Net bottleneck at the adder 450. Thus, the neural network architecture 400 is a multi-domain architecture.

According to various implementations, the neural network architecture 400 shown in FIG. 4 is one example of a neural network that can be utilized for audio source separation. In various examples, the neural network can have an architecture similar to demucs, and/or a hybrid demucs. In some examples, the architecture can include a U-Net encoder and/or decoder structure. In some examples, the encoder and decoder can have symmetric structures. In some examples, an encoder layer includes a convolution. In one example, the convolution can have a kernel size of eight, a stride of four, a first layer with a fixed number of channels (e.g., 48 or 64), and a doubling of the number of channels in subsequent layers. The neural network architecture can include a rectified linear unit (ReLU), and the neural network architecture can include a 1×1 convolution with a Gated Linear Unit Activation. A decoder layer can sum the contribution from the U-Net skip connection and the previous layer, apply a 1×1 convolution with GLU. In some examples, the audio input data is 44.1 kHz audio. In some examples, the input audio data is upsampled by a factor of two before it is input to the encoder (in order to limit aliasing from the outermost layers), and the output from the decoder is downsampled by a factor of two.

In some examples, the neural network is a hybrid demucs inspired architecture and includes multi-domain analysis and prediction capabilities. The architecture can include a temporal branch, a spectral branch, and shared layers. The temporal branch receives as input a waveform and processes the waveform. In some examples, the temporal branch includes Gaussian Error Linear Units (GELU) for activations. In some examples, the temporal branch includes multiple layers (e.g., five layers) and the layers reduce the number of time steps by a factor of 1024. The spectral branch receives as input a spectrogram generated using a STFT function. The spectrogram is a frequency representation of the waveform input to the temporal branch. In some examples, the STFT is obtained over 4096 time steps with a hop length of 1024. Thus, in some examples, the number of time steps for the spectral branch matches that of the output of the temporal branch encoder. In some examples, the spectral branch performs the same convolutions as the temporal branch, but the spectral branch performs the convolutions in the frequency dimension. Each layer of the spectral branch reduces the number of frequencies by a factor of four. In some examples, a fifth layer of the spectral branch reduces the number of frequencies by a factor of eight.

In some examples, the spectral branch can perform frequency-wise convolutions. The number of frequency bins can be divided by four at each layer of the neural network. In some examples, the last layer has eight frequency bins, which can be reduced to one with a convolution with a kernel size of eight and no padding. In some examples, the spectrogram input to the neural network can be represented as an amplitude spectrogram, or as complex numbers. In some examples, the spectral branch output is transformed to a waveform, and summed with the temporal branch output, and the output from the summer is in the waveform domain.

### Example Method for Sound Source Separation

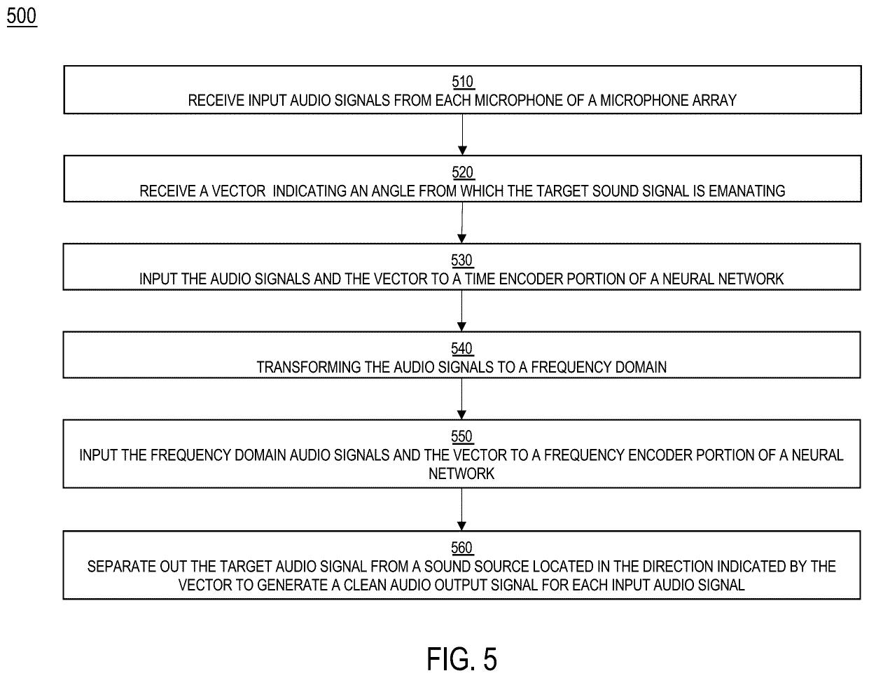

FIG. 5 is a flow chart of an example method 500 for sound source separation, in accordance with various embodiments. At step 510, an input audio signal is received. The input audio signal can include audio signals from multiple talkers. In some examples, the input audio signal is received at a microphone array including two or more microphones. The input audio signal as received at each microphone can be received as a separate input. For example, with reference to FIG. 4, the audio input at a first microphone of a microphone array can be received as a first time domain audio input 412a, and the audio input at a second microphone of a microphone array can be received as a second time domain audio input 412b. At step 520, a one-dimensional vector is received, where the one-dimensional vector indicates the angle from which a target sound signal is emanating. In general, the vector indicates the angle at which a selected talker is located with respect to the microphone array.

At step 530, the input audio signal as received at each microphone of the microphone array is input to a time encoder portion of a neural network. In particular, the input audio signal is input to a time encoder such as the time encoder 410 shown in FIG. 4. At step 540, the input audio signals as received at each microphone are transformed to a frequency domain. In some examples, a Fourier Transform is used to transform the signal, and in some examples, a STFT is used to transform the signal to a frequency domain signal. The STFT can output a frequency domain signal for each audio signal as received at each respective microphone. At step 550, the converted input audio signal is input to a frequency encoder portion of a neural network, such as the frequency encoder 420 shown in FIG. 4.

At step 560, the target audio signal from a sound source located in the direction as indicated by the input vector is separated out and a clean audio output signal is generated for each input audio signal. As described above, a neural network such as the DNN module 301 of FIG. 3 or the neural network 400 of FIG. 4 can generate the cleaned audio signals based on the input vector and the audio input signal at each microphone of the microphone array. According to various examples, the audio input signals are cleaned of sounds not originating from the direction of the target source talker as indicated by the input vector. A time decoder portion of a neural network can be used to decode the time encoded and frequency encoded input signals and generate the cleaned output signal. The cleaned audio output signal is output from the neural network.

### Example Microphone Array and Talker Location Points for Sound Source Separation

FIG. 6A is a diagram illustrating a simulated room 610 having a microphone array 615, in accordance with various examples. The diagram also includes multiple points 620 arranged in a semicircle around the microphone array 615. The points 620 represent audio sources. The multiple points 620 are spaced apart by 2 degrees of separation around the semicircle, and the multiple points 620 can represent talkers at 45 directions. In some examples, the multiple points 620 can be spaced apart by a different spacing, such as by about 1 degree of separation, by about 3 degrees of separation, by about 4 degrees of separation, or by about 5 degrees of separation. In some examples, the multiple points 620 can be spaced apart by less than about 1 degree of separation, anywhere between 1-5 degrees of separation, or more than about 5 degrees of separation.

The simulated room 610 can have any selected size. In some examples, the simulated room 610 can be used to train the audio source separation system using synthetic data and multiple impulse responses for multiple respective rooms. Each training sample can be virtually unique by randomly creating a stereo mix with a scene in which each of multiple audio sources are located at different positions. Multiple simulated rooms 610 can be simulated to generate room impulse responses (RIR) of sound originating from each of the multiple points 620 in each of the various simulated rooms 610.

FIG. 6B illustrates examples of RIRs obtained for a simulated room, in accordance with various embodiments. In some examples, the top graph of FIG. 6B shows the RIRs at the microphone array 615 for a source originating from a point to the right of the microphones 615 (e.g., 0 degrees), the middle graph of FIG. 6B shows the RIRs at the microphone array 615 for a source originating from a point in front of the microphones 615 (e.g., 90 degrees), and the bottom graph of FIG. 6B shows the RIRs at the microphone array 615 for a source originating from a point to the left of microphones 615 (e.g., 180 degrees). When the source originates from a point to the right of the microphones 615, as shown in the top graph, the audio arrives at the right microphone of the microphone array before it arrives at the left microphone of the microphone array. Thus, as shown in the top graph, the right microphone audio RIR 630 arrives before the left microphone audio RIR 635. Similarly, when the source originates from a point to the left of the microphones 615, as shown in the bottom graph, the audio arrives at the left microphone of the microphone array before it arrives at the right microphone of the microphone array. Thus, as shown in the top graph, the left microphone audio RIR 635 arrives before the right microphone audio RIR 630. When the source originates from a point in front of the microphones 615, as shown in the middle graph, the audio arrives at the right and left microphones of the microphone array at approximately the same time, and thus the audio RIRs 640 overlap. In various examples, depending on the shape of the room and other environmental factors, the audio received at each microphone of the microphone array may begin to vary somewhat at later time points, as the sounds has reflected off various surfaces.

### Example Computing Device

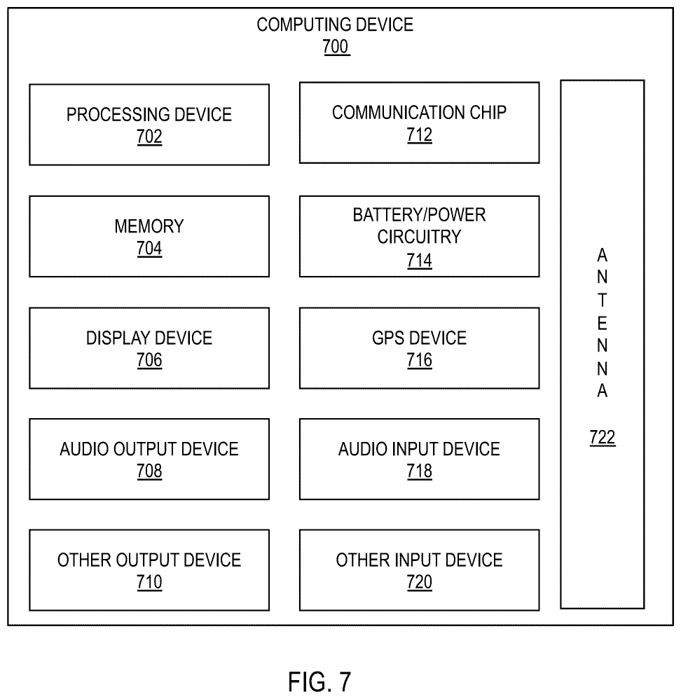

FIG. 7 is a block diagram of an example computing device 700, in accordance with various embodiments. In some embodiments, the computing device 700 may be used for at least part of the DNN module 301 in FIG. 3, and the neural network 400 of FIG. 4. A number of components are illustrated in FIG. 7 as included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, but the computing device 700 may include interface circuitry for coupling to the one or more components. For example, the computing device 700 may not include a display device 706, but may include display device interface circuitry (e.g., a connector and driver circuitry) to which a display device 706 may be coupled. In another set of examples, the computing device 700 may not include a video input device 718 or a video output device 708, but may include video input or output device interface circuitry (e.g., connectors and supporting circuitry) to which a video input device 718 or video output device 708 may be coupled.

The computing device 700 may include a processing device 702 (e.g., one or more processing devices). The processing device 702 processes electronic data from registers and/or memory to transform that electronic data into other electronic data that may be stored in registers and/or memory. The computing device 700 may include a memory 704, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 704 may include memory that shares a die with the processing device 702. In some embodiments, the memory 704 includes one or more non-transitory computer-readable media storing instructions executable for occupancy mapping, e.g., the method 600 described above in conjunction with FIG. 6 or some operations performed by the DNN system 301 in FIG. 3 or operations performed by the neural network 400 of FIG. 4. The instructions stored in the one or more non-transitory computer-readable media may be executed by the processing device 702.

In some embodiments, the computing device 700 may include a communication chip 712 (e.g., one or more communication chips). For example, the communication chip 712 may be configured for managing wireless communications for the transfer of data to and from the computing device 700. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 712 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 712 may operate in accordance with other wireless protocols in other embodiments. The computing device 700 may include an antenna 722 to facilitate wireless communications and/or to receive other wireless communications (such as AM or FM radio transmissions).

In some embodiments, the communication chip 712 may manage wired communications, such as electrical, optical, or any other suitable communication protocols (e.g., the Ethernet). As noted above, the communication chip 712 may include multiple communication chips. For instance, a first communication chip 712 may be dedicated to shorter-range wireless communications such as Wi-Fi or Bluetooth, and a second communication chip 712 may be dedicated to longer-range wireless communications such as global positioning system (GPS), EDGE, GPRS, CDMA, WiMAX, LTE, EV-DO, or others. In some embodiments, a first communication chip 712 may be dedicated to wireless communications, and a second communication chip 712 may be dedicated to wired communications.

The computing device 700 may include battery/power circuitry 714. The battery/power circuitry 714 may include one or more energy storage devices (e.g., batteries or capacitors) and/or circuitry for coupling components of the computing device 700 to an energy source separate from the computing device 700 (e.g., AC line power).

The computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

The computing device 700 may include a video output device 708 (or corresponding interface circuitry, as discussed above). The video output device 708 may include any device that generates an audible indicator, such as speakers, headsets, or earbuds, for example.

The computing device 700 may include a video input device 718 (or corresponding interface circuitry, as discussed above). The video input device 718 may include any device that generates a signal representative of a sound, such as microphones, microphone arrays, or digital instruments (e.g., instruments having a musical instrument digital interface (MIDI) output).

The computing device 700 may include a GPS device 716 (or corresponding interface circuitry, as discussed above). The GPS device 716 may be in communication with a satellite-based system and may receive a location of the computing device 700, as known in the art.

The computing device 700 may include another output device 710 (or corresponding interface circuitry, as discussed above). Examples of the other output device 710 may include a video codec, a video codec, a printer, a wired or wireless transmitter for providing information to other devices, or an additional storage device.

The computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 700 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 700 may be any other electronic device that processes data.

### Selected Examples

The following paragraphs provide various examples of the embodiments disclosed herein.

Example 1 provides a computer-implemented method, including receiving a plurality of audio input signals from a plurality of microphones in a microphone array; receiving a vector indicating a selected angle from which a target audio signal is emanating relative to the microphone array; inputting the plurality of audio input signals and the vector into a time domain encoder of a neural network, where the time domain encoder includes a plurality of time domain encoder layers; transforming, at the neural network, the plurality of audio input signals to respective frequency domain signals; inputting the respective frequency domain signals and the vector to a frequency domain encoder of the neural network encoder, where the frequency domain encoder includes a plurality of frequency domain encoder layers; and separating out the target audio signal as indicated by the selected angle in the vector to generate a clean audio output signal.

Example 2 provides the computer-implemented method of example 1, further including inputting the plurality of audio input signals and the vector to a first time domain encoder layer of the plurality of time domain encoder layers; and outputting a plurality of time domain encoded signals from the time domain encoder.

Example 3 provides the computer-implemented method of example 2, where a second time domain encoder layer of the plurality of time domain encoder layers receives an output from the first time domain encoder layer and the vector.

Example 4 provides the computer-implemented method of example 3, where a number of channels output from each of the plurality of time domain encoder layers is greater than a number of channels input to each of the plurality of time domain encoder layers.

Example 5 provides the computer-implemented method of example 2, further including inputting the respective frequency domain signals to a first frequency domain encoder layer of the plurality of frequency domain encoder layers; and outputting a plurality of frequency domain encoded signals from the frequency domain encoder.

Example 6 provides the computer-implemented method of example 5, where the neural network includes an adder, and further including adding the plurality of time domain encoded signals and the plurality of frequency domain encoded signals to generate a plurality of added encoded signals, and inputting the plurality of added encoded signals to a time domain decoder.

Example 7 provides the computer-implemented method of example 1, where receiving the vector includes receiving a plurality of elements, each element representing a potential angle with respect to the microphone array, and where the plurality of elements includes a selected element representing the selected angle.

Example 8 provides the computer-implemented method of example 7, where the plurality of elements includes the selected element, at least two neighboring elements adjacent to the selected element, and a plurality of unselected elements, and where a respective unselected element value for each of the plurality of unselected elements is zero and a selected element value for the selected element is one.

Example 9 provides the computer-implemented method of example 1, further including training the neural network using synthetic audio samples generated using a plurality of simulated rooms and corresponding room impulse responses of sound emanating from a plurality of directions.

Example 10 provides one or more non-transitory computer-readable media storing instructions executable to perform operations, the operations including receiving a plurality of audio input signals from a plurality of microphones in a microphone array; receiving a vector indicating a selected angle from which a target audio signal is emanating relative to the microphone array; inputting the plurality of audio input signals and the vector into a time domain encoder of a neural network, where the time domain encoder includes a plurality of time domain encoder layers; transforming, at the neural network, the plurality of audio input signals to respective frequency domain signals; inputting the respective frequency domain signals and the vector to a frequency domain encoder of the neural network encoder, where the frequency domain encoder includes a plurality of frequency domain encoder layers; and separating out the target audio signal as indicated by the selected angle in the vector to generate a clean audio output signal.

Example 11 provides the one or more non-transitory computer-readable media of example 10, the operations further including inputting the plurality of audio input signals and the vector to a first time domain encoder layer of the plurality of time domain encoder layers; and outputting a plurality of time domain encoded signals from the time domain encoder.

Example 12 provides the one or more non-transitory computer-readable media of example 11, the operations further including inputting the respective frequency domain signals to a first frequency domain encoder layer of the plurality of frequency domain encoder layers; and outputting a plurality of frequency domain encoded signals from the frequency domain encoder.

Example 13 provides the one or more non-transitory computer-readable media of example 12, where the neural network includes an adder, and the operations further including adding the plurality of time domain encoded signals and the plurality of frequency domain encoded signals to generate a plurality of added encoded signals, and inputting the plurality of added encoded signals to a time domain decoder.

Example 14 provides the one or more non-transitory computer-readable media of example 10, where receiving the vector includes receiving a plurality of elements, each element representing a potential angle with respect to the microphone array, and where the plurality of elements includes a selected element representing the selected angle.

Example 15 provides the one or more non-transitory computer-readable media of example 10, the operations further including training the neural network using synthetic audio samples generated using a plurality of simulated rooms and corresponding room impulse responses of sound emanating from a plurality of directions.

Example 16 provides an apparatus, including a computer processor for executing computer program instructions; and a non-transitory computer-readable memory storing computer program instructions executable by the computer processor to perform operations including receiving a plurality of audio input signals from a plurality of microphones in a microphone array; receiving a vector indicating a selected angle from which a target audio signal is emanating relative to the microphone array; inputting the plurality of audio input signals and the vector into a time domain encoder of a neural network, where the time domain encoder includes a plurality of time domain encoder layers; transforming, at the neural network, the plurality of audio input signals to respective frequency domain signals; inputting the respective frequency domain signals and the vector to a frequency domain encoder of the neural network encoder, where the frequency domain encoder includes a plurality of frequency domain encoder layers; and separating out the target audio signal as indicated by the selected angle in the vector to generate a clean audio output signal.

Example 17 provides the apparatus of example 16, the operations further including inputting the plurality of audio input signals and the vector to a first time domain encoder layer of the plurality of time domain encoder layers; and outputting a plurality of time domain encoded signals from the time domain encoder.

Example 18 provides the apparatus of example 16, the operations further including inputting the respective frequency domain signals to a first frequency domain encoder layer of the plurality of frequency domain encoder layers; and outputting a plurality of frequency domain encoded signals from the frequency domain encoder.

Example 19 provides the apparatus of example 18, where the neural network includes an adder, and the operations further including adding the plurality of time domain encoded signals and the plurality of frequency domain encoded signals to generate a plurality of added encoded signals, and inputting the plurality of added encoded signals to a time domain decoder.

Example 20 provides the apparatus of example 16, where receiving the vector includes receiving a plurality of elements, each element representing a potential angle with respect to the microphone array, and where the plurality of elements includes a selected element representing the selected angle.

Example 21 provides the method and/or apparatus of any of the above examples, wherein the selected angle is a first selected angle and wherein the target audio signal is a first target audio signal, and wherein receiving the vector includes receiving the vector indicating a second selected angle from which a second target audio signal is emanating relative to the microphone array.

Example 21 provides the method and/or apparatus of any of the above examples, wherein the clean audio output signal is a first clean audio output signal, and wherein separating out the target audio signal includes separating out the target audio signal as indicated by the first selected angle in the vector to generate the first clean audio output signal and separating out the target audio signal as indicated by the second selected angle in the vector to generate a second clean audio signal.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving a plurality of audio input signals from a plurality of microphones in a microphone array;
receiving a vector indicating a selected angle from which a target audio signal is emanating relative to the microphone array;
inputting the plurality of audio input signals and the vector into a time domain encoder of a neural network, wherein the time domain encoder includes a plurality of time domain encoder layers;
transforming, at the neural network, the plurality of audio input signals to respective frequency domain signals;
inputting the respective frequency domain signals and the vector to a frequency domain encoder of the neural network, wherein the frequency domain encoder includes a plurality of frequency domain encoder layers; and
separating out the target audio signal as indicated by the selected angle in the vector to generate a clean audio output signal.

2. The computer-implemented method of claim 1, further comprising:
inputting the plurality of audio input signals and the vector to a first time domain encoder layer of the plurality of time domain encoder layers; and
outputting a plurality of time domain encoded signals from the time domain encoder.

3. The computer-implemented method of claim 2, wherein a second time domain encoder layer of the plurality of time domain encoder layers receives an output from the first time domain encoder layer and the vector.

4. The computer-implemented method of claim 3, wherein a number of channels output from each of the plurality of time domain encoder layers is greater than a number of channels input to each of the plurality of time domain encoder layers.

5. The computer-implemented method of claim 2, further comprising:
inputting the respective frequency domain signals to a first frequency domain encoder layer of the plurality of frequency domain encoder layers; and
outputting a plurality of frequency domain encoded signals from the frequency domain encoder.

6. The computer-implemented method of claim 5, wherein the neural network includes an adder, and further comprising adding the plurality of time domain encoded signals and the plurality of frequency domain encoded signals to generate a plurality of added encoded signals, and inputting the plurality of added encoded signals to a time domain decoder.

7. The computer-implemented method of claim 1, wherein receiving the vector includes receiving a plurality of elements, each element representing a potential angle with respect to the microphone array, and wherein the plurality of elements includes a selected element representing the selected angle.

8. The computer-implemented method of claim 7, wherein the plurality of elements includes the selected element, at least two neighboring elements adjacent to the selected element, and a plurality of unselected elements, and wherein a respective unselected element value for each of the plurality of unselected elements is zero and a selected element value for the selected element is one.

9. The computer-implemented method of claim 1, further comprising training the neural network using synthetic audio samples generated using a plurality of simulated rooms and corresponding room impulse responses of sound emanating from a plurality of directions.

10. One or more non-transitory computer-readable media storing instructions executable to perform operations, the operations comprising:
receiving a plurality of audio input signals from a plurality of microphones in a microphone array;
receiving a vector indicating a selected angle from which a target audio signal is emanating relative to the microphone array;
inputting the plurality of audio input signals and the vector into a time domain encoder of a neural network, wherein the time domain encoder includes a plurality of time domain encoder layers;
transforming, at the neural network, the plurality of audio input signals to respective frequency domain signals;
inputting the respective frequency domain signals and the vector to a frequency domain encoder of the neural network, wherein the frequency domain encoder includes a plurality of frequency domain encoder layers; and
separating out the target audio signal as indicated by the selected angle in the vector to generate a clean audio output signal.

11. The one or more non-transitory computer-readable media of claim 10, the operations further comprising:
inputting the plurality of audio input signals and the vector to a first time domain encoder layer of the plurality of time domain encoder layers; and
outputting a plurality of time domain encoded signals from the time domain encoder.

12. The one or more non-transitory computer-readable media of claim 11, the operations further comprising:
inputting the respective frequency domain signals to a first frequency domain encoder layer of the plurality of frequency domain encoder layers; and
outputting a plurality of frequency domain encoded signals from the frequency domain encoder.

13. The one or more non-transitory computer-readable media of claim 12, wherein the neural network includes an adder, and the operations further comprising:
adding the plurality of time domain encoded signals and the plurality of frequency domain encoded signals to generate a plurality of added encoded signals, and
inputting the plurality of added encoded signals to a time domain decoder.

14. The one or more non-transitory computer-readable media of claim 10, wherein receiving the vector includes receiving a plurality of elements, each element representing a potential angle with respect to the microphone array, and wherein the plurality of elements includes a selected element representing the selected angle.

15. The one or more non-transitory computer-readable media of claim 10, the operations further comprising training the neural network using synthetic audio samples generated using a plurality of simulated rooms and corresponding room impulse responses of sound emanating from a plurality of directions.

16. An apparatus, comprising:
a computer processor for executing computer program instructions; and
a non-transitory computer-readable memory storing computer program instructions executable by the computer processor to perform operations comprising:
receiving a plurality of audio input signals from a plurality of microphones in a microphone array;
receiving a vector indicating a selected angle from which a target audio signal is emanating relative to the microphone array;
inputting the plurality of audio input signals and the vector into a time domain encoder of a neural network, wherein the time domain encoder includes a plurality of time domain encoder layers;
transforming, at the neural network, the plurality of audio input signals to respective frequency domain signals;
inputting the respective frequency domain signals and the vector to a frequency domain encoder of the neural network, wherein the frequency domain encoder includes a plurality of frequency domain encoder layers; and
separating out the target audio signal as indicated by the selected angle in the vector to generate a clean audio output signal.

17. The apparatus of claim 16, the operations further comprising:
inputting the plurality of audio input signals and the vector to a first time domain encoder layer of the plurality of time domain encoder layers; and
outputting a plurality of time domain encoded signals from the time domain encoder.

18. The apparatus of claim 17, the operations further comprising:
inputting the respective frequency domain signals to a first frequency domain encoder layer of the plurality of frequency domain encoder layers; and
outputting a plurality of frequency domain encoded signals from the frequency domain encoder.

19. The apparatus of claim 18, wherein the neural network includes an adder, and the operations further comprising:
adding the plurality of time domain encoded signals and the plurality of frequency domain encoded signals to generate a plurality of added encoded signals, and
inputting the plurality of added encoded signals to a time domain decoder.

20. The apparatus of claim 16, wherein receiving the vector includes receiving a plurality of elements, each element representing a potential angle with respect to the microphone array, and wherein the plurality of elements includes a selected element representing the selected angle.
